(19) United States
(12) Patent Application Publication
(10) Pub. No.: US 2003/0103248 A1
(43) Pub. Date: Jun. 5, 2003

(54) Enhanced sheet insertion for a document production system

(76) Inventors: Thomas K. Sciurba, Webster, NY (US); Michael T. Dobbertin, Honeoye, NY (US)

Correspondence Address: Kevin L. Leffel, Heidelberg Digital L.L.C., 2600 Manitou Road, Rochester, NY, 14624, US

(21) Appl. No.: 10/278,435

(22) Filed: Oct. 23, 2002

Related U.S. Application Data
(60) Provisional application No. 60/345,943, filed on Oct. 26, 2001.

(51) Int. Cl. H04N 1/04

(52) U.S. Cl. 358/498

(57) ABSTRACT

A method and system for managing a document production system comprises detecting a first time period for at least one marking-engine originating sheet to reach a fixed reference point via a first media path of the document production system. A second time period is detected for at least one inserter-originating sheet to reach a fixed reference point via a second media path of the document production system. A feed timing command of an inserter is adjusted so the first time period and the second time period are synchronized for the coordinated introduction of at least one inserter-originating sheet into a set of marking-engine originating sheets at a combination point.

This application claims the benefit of U.S. Provisional Application No. 60/345,943, filed Oct. 26, 2001.

### FIELD OF INVENTION

This invention relates to enhanced sheet insertion for a document production system.

### BACKGROUND

A document production system may include an electrophotographic printer or copier for providing printed documents. Further, the document production system may comprise an in-line document production system that features an in-line finishing system for processing a document after printing or copying.

A user may require a document that is a compilation of printed and blank media. For example, blank media may include covers, tabs, and other media that do not require any images or additional images. In one prior art configuration, document production systems have routed blank media through the printer or copier without printing on the blank media to form a desired compilation of printed and blank media. However, routing blank media the paper through the printer of the document production system may detract from the available printing time of the printer that could otherwise be used to print pages of one or more documents. Thus, a need exists for improving the efficiency of a document production system that produces compilations of printed and blank media.

### SUMMARY

A method and system for managing a document production system comprises detecting a first time period for at least one marking-engine originating sheet to reach a fixed reference point via a first media path of the document production system. A second time period is detected for at least one inserter-originating sheet to reach a fixed reference point via a second media path of the document production system. A feed timing command of an inserter is adjusted so the first time period and the second time period are synchronized for the coordinated introduction of at least one inserter-originating sheet into a set of marking-engine originating sheets at a combination point.

### BRIEF DESCRIPTION OF THE DRAWINGS

FIG. 1 is a block diagram of a document processing system in accordance with the invention.

FIG. 2 is a side view of an inserter in accordance with the invention.

FIG. 3 is a flow chart of a method for document production in accordance with the invention.

FIG. 4 is a flow chart of a method for document production in accordance with the invention.

FIG. 5 is a side view of an inserter that features an inverter in accordance with the invention.

FIG. 6 is an alternate embodiment of a system for document production featuring an inserter with an inverter in accordance with the invention.

### DETAILED DESCRIPTION

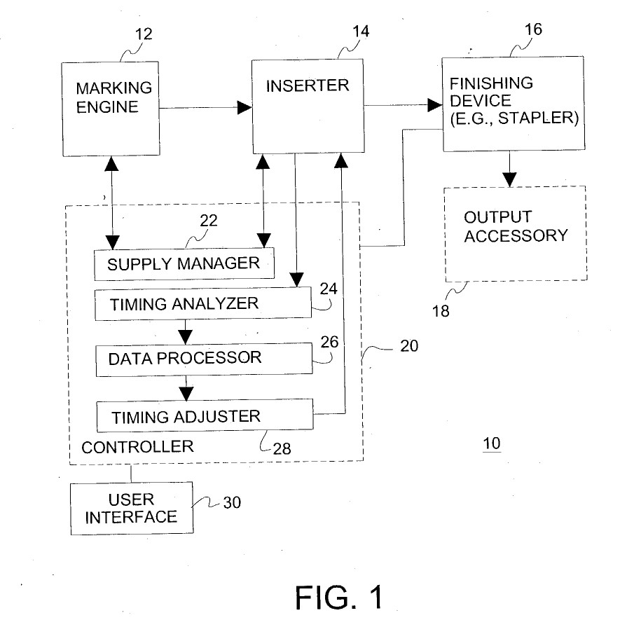

In accordance with the invention, FIG. 1 illustrates a document production system 10. The document production system 10 of FIG. 1 comprises a marking engine 12 coupled to an inserter 14. In turn, the inserter 14 is coupled to a finishing device 16. The finishing device 16 may provide an output to an output accessory 18. A controller 20 may control the marking engine 12, the inserter 14 and the finishing device 16. A user interface 30 may be coupled to the controller 20 to support input and output of a user with respect to the document production system 10.

In one embodiment, the controller 20 includes a supply manager 22, a timing analyzer 24, a data processor 26 and a timing adjuster 28. The timing analyzer 24 may communicate with a data processor 26. In turn, the data processor 26 may communicate with a timing adjuster 28.

The user interface 30 and the supply manager 22 may support the identification or description of media that is associated with corresponding input media sources. The input media sources may comprise supply inputs, paper trays or other input sources that are associated with the marking engine 12, the inserter 14, or both.

The supply manager 22 may establish an association of a particular medium with a corresponding input media source based upon user input entered via a user interface 30. The supply manager 22 may also track the usage, the inventory, or the remaining supply of a media associated with one or more corresponding input media sources. The supply manager 22 may determine whether a desired medium is available or not based upon the supply of one or more input media sources. The supply manager 22 may allocate a particular medium for a print job or may pause or stop a print job where a supply medium is no longer available to prompt the user to add additional media (e.g., paper).

The timing analyzer 24 may establish time relationships between a timing reference signal (e.g., a machine timing bus) of a document production system 10 and the time period or rate of a fed sheet traversing a defined media path (e.g., paper path) of a document production system 10. The timing analyzer 24 may measure or detect time periods or rates associated with the routing of media via defined media paths of the inserter 14 and the marking engine 12.

The data processor 26 may determine if the time periods or the rates associated with the routing of media in the marking engine 12 and the inserter 14 are coordinated or synchronized to properly facilitate the combination of the media (e.g., different media) into a print job at the proper time.

The timing adjuster 28 may generate a timing command to the inserter 14 such that the inserter 14 adjusts the time period or feed time for inserter-originating media to compensate for fluctuation in the time period of the marking engine 12 or other discrepancies or variations of the marking engine 12 that might otherwise cause the marking engine 12 and the inserter 14 to not be fully coordinated for the execution of a print job.

The inserter 14 is positioned in a media path (e.g., paper path) between the marking engine 12 and the finishing device 16. The finishing device 16 may comprise a stapler, a stacker, a sorter, or a device for execution of other post-marking activities.

The output accessory 18 may facilitate the presentation of the document or print job in a particular manner. One or more optional output accessories 18 may be located downstream of the finishing device 16. The output accessory 18 is shown in dashed lines to indicate that the output accessory 18 is optional.

The inserter 14 is integrated in the document production system 10 to promote reliability, flexibility, and/or productivity of the document production system 10. For example, the inserter 14 supports the user interface 30; the controller 20 coordinates timing and control of the inserter 14 with respect to the marking engine 12; the media path provides the coordinated transfer of fed media from the marking engine 12 to the inserter 14, and the media path provides the coordinated transfer of fed media from the inserter 14 to the finishing device 16.

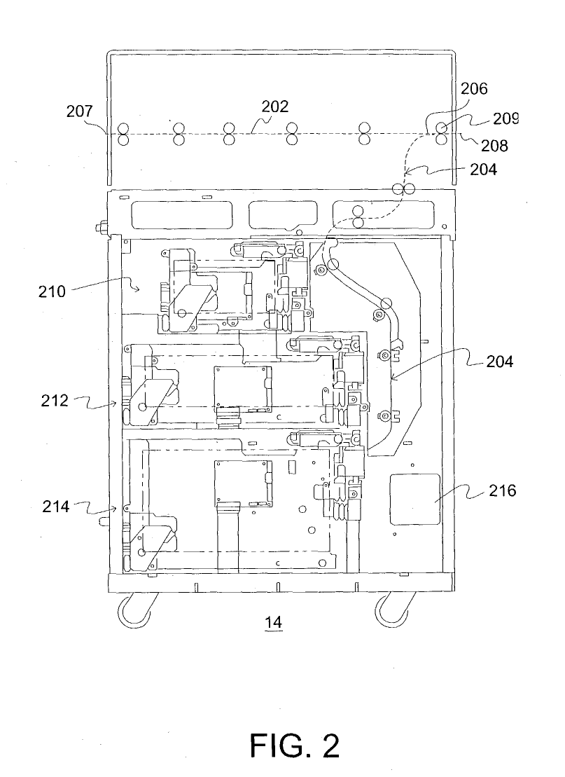

In FIG. 2, the inserter 14 has a transport mechanism that includes a first media path 202 (e.g., a generally horizontal bypass path) and a second media path 204 (e.g., a generally vertical media path). In one embodiment, the first media path 202 comprises a generally horizontal bypass path that extends from the entrance 207 to the exit 208 of the inserter 14. The first media path 202 feeds sheets of paper from left to right as illustrated in FIG. 2. The paper is fed from the entrance 207 to the exit 208. The entrance 207 may receive media outputted from the marking engine 12 and the exit 208 may pass the media into a finishing device 16.

The second media path 204 may comprise a generally vertical media path that extends from an input media source to a combination point of merger with first media path 202. The second media path 204 feeds sheets of paper from at least one input media source (210, 212 or 214) in a generally upward direction as shown in FIG. 2. Each input media source (210, 212, or 214) may comprise a top-fed, vacuum corrugated feed device.

The second media path 204 merges with the first media path 202 at a combination point 206 near the exit 208. The inserter 14 inserts a medium or media from an input media source (210, 212, or 214) at select times from the second media path 204 into the first media path 202 at the combination point 206 in a synchronized time-coordinated manner to allow the composition or compilation of a print job.

The print job may incorporate primary media that is marked from the marking engine 12 and secondary media from the inserter 14 which is stored in at least one of a first media source 210, a second media source 212, and a third media source 214. The secondary media may comprise a blank media, an unmarked media, or a preprinted media, for example.

The first media source 210, the second media source 212, and the third media source 214 may comprise holders that accommodate commercially available sizes of media with various capacities. For example, the first media source 210 may comprise a tray that holds up to 1,000 sheets of 9″×14″ media or paper; the second media source 212 may comprise a tray that holds up to 1,000 sheets of 14″×17″ media or paper; and the third media source 214 may comprise a tray that holds up to 2,000 sheets of 14″×17″ paper.

A drive motor 216 or drive system imparts movement of rollers or other members associated with the transport system for the first media path 202 and the second media path 204. Although three input media sources that feed the second media path 204, or a variant thereof, are shown in FIG. 2, the inserter 14 may have any number of input media sources and still fall within the scope of the invention.

The first media path 202 and the second media path 204 merge inserter-originating sheets fed from an input media source (210, 212, or 214) of the inserter 14 trays with marking-engine sheets coming from the marking engine 12. The height of the entrance 207 of the first media path 202 of the inserter 14 is substantially the same as or otherwise aligned with the exit from the marking engine 12 to allow the transfer of at least one sheet between the marking engine 12 and the inserter 14. Similarly, the height of the exit 208 of the first media path 202 of the inserter 14 is the same as the height of the entrance of the finishing device 16 (e.g., a stapler).

The inserter 14 supports accurate timing control to promote integration of the inserter 14 into the document production system 10. To this end, the inserter 14 has access to a machine timing bus (MTB) that allows communication of timing information between the marking engine 12 and the inserter 14. For example, the machine timing bus (MTB) signal may be passed along from the marking engine 12 to the inserter 14. In one embodiment, the MTB signal is a serial signal that includes critical timing parameters of the marking engine 12, such as the start of an image frame and image encoder pulses. This MTB signal enables accurate synchronization of the inserter 14 and marking engine 12.

The machine timing bus signal supports feeding at least one inserter-originating sheet between marking-engine originating sheets coming from the marking engine 12 in a seamless manner. In fact, whenever there is a skip between sheets exiting the marking engine 12, one or more inserter-originating sheets can be fed to fill the void (i.e., lack of a sheet) and to maintain the previous sheet output rate of the marking engine 12 without any degradation in productivity. A skip refers to a sheet that is not fed to the marking engine 12 for marking or printing from a marking-engine originating source or otherwise. Thus, no sheet may be present between other marking-engine originating sheets in the marking engine or the first media path 202. Skips may occur for a variety of reasons, including, but not limited to, processing complex images, adjusting process control, and most notably, completing duplex imaging. A skip may be used to realign a sheet for later marking or printing. The effective productivity of the document production system 10 is increased with the cooperation of the inserter 14 because the document production system 10 may assemble a document even during the occurrence of one or more skips. For example, the inserter 14 may insert secondary media into the first media path 202 where skips are present and where secondary media 204 are desired for a print job.

For duplex copying or printing, two images are printed on opposite sides of each duplex sheet. For a marking engine 12 with only a single-sided imaging capability, the document processing system 10 may have at least as many skips as there are sheets exiting the marking engine 12. A marking engine 12 with single-sided imaging may operate in accordance with one of two alternate modes to produce duplex printed sheets: an interleave mode and a batch mode. In the interleave mode, there is a skip between each duplex sheet because a duplex sheet (with printing a first image on one side) is diverted to the duplex path to receive a second image on the opposite side. In the batch mode, a batch of sheets receive their image sequentially on one side and then are directed through the duplex path to receive their second image on the opposite side of the sheets. In the batch mode, the skips all come in a bunch between batches or groups of duplex sheets.

The precise media-feed timing combined with the media path configuration depicted in the attached FIG. 2 enables potential productivity improvement. Because the media paths converge smoothly in the inserter 14, one or more inserted sheets (from the second media path 204) can be stacked or placed directly beneath the marking engine-originating sheets. Alternately, one or more inserter-originating sheets may be shingled with marking engine originating sheets, rather than stacked directly on top of each other. The inserter 14 may stack or shingle the sheets as required for compatibility with a downstream device, such as a finishing device 16 or an output accessory 18. In one embodiment, the user may enter data into a user interface 30 on the downstream devices as to their compatibility with stacking or shingling of the sheets.

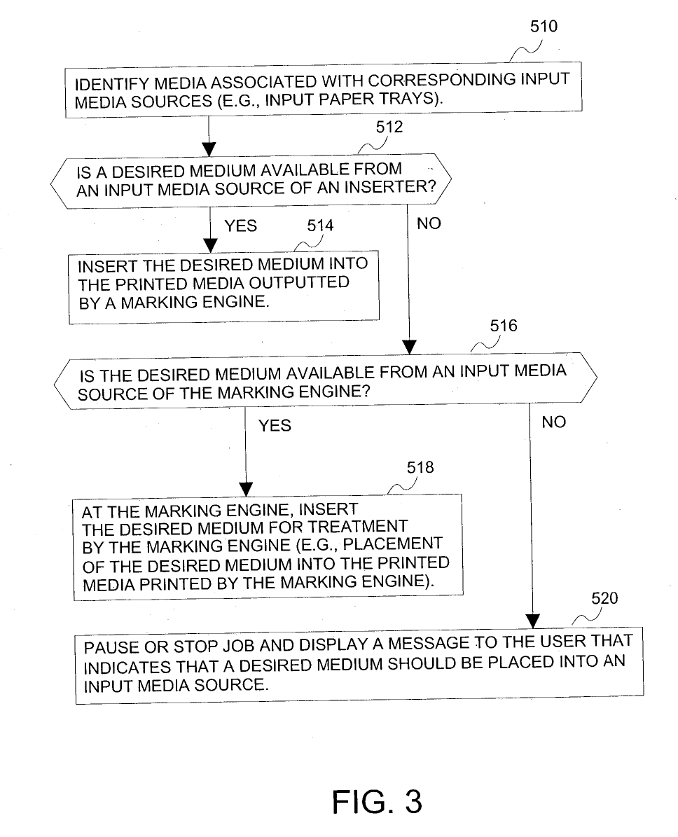

FIG. 3 is a flow chart of a method for document production in accordance with the system. The supply manager 22 and the controller 20 may support the execution of the method of FIG. 3. The method of FIG. 3 starts at step S10.

In step S10, the user interface 30 or document production system 10 supports identification of media associated with corresponding input media sources (e.g., input paper trays). The media may comprise paper, cardboard stock, plastic sheets, polymeric sheets, film, a printable medium, or any other medium used in document production. The identification of media associated with corresponding input media sources may include input media sources of both the inserter 14 and the marking engine 12. In one example, a user may enter an association of a respective particular medium with a corresponding input media source. Further, the user may enter or establish the media identifiers of different media associated with corresponding input media source identifiers.

In step S12, the supply manager 22 or the controller 20 determines if the desired medium is available from at least one input media source of an inserter 14. In one embodiment, the input media sources of the inserter 14 include the first input media source 210, the second input media source 212, and the third input media source 214. If the desired medium is available from the input media source of an inserter 14, the method continues with step S14. However, if the desired medium is not available from a supply input of an inserter 14, the method continues with step S16.

In step S14, the controller 20 sends a command to the inserter 14 to authorize the insertion of the desired medium into the printed media outputted by a marking engine 12. The inserter 14 inserts the desired medium into the printed media output as required by the print job. For example, the inserter 14 may insert the desired medium (e.g., an inserter-originating sheet) from an input media source after a specified marking engine-originating sheet, before a particular marking engine-originating sheet, or between two marking engine-originating sheets. The parameters of the print job and definition of the print job may be defined by the entries or selections of a user via the user interface 30.

In step S16, the supply manager 22 of the controller 20 determines if the desired medium is available from an input media source (not shown) of the marking engine 12. For example, a marking engine 12 may include one or more input media sources (e.g., input paper trays). If the desired medium is available from at least one media input source of the marking engine 12, the method continues with step S18. However, if the desired medium is not available from the input media source of the marking engine 12, then the method continues with step S20.

In step S18 at the marking engine 12, the desired medium is inserted for processing by the marking engine 12 per the requirements of the print job. The desired medium may comprise a primary medium to be printed on or a secondary medium to be routed without printing on it. In one example, one or more sheets of the desired medium from the marking engine 12 are inserted into printed medium at the marking engine 12. The requirements of the print job are defined by a user via the user interface 30 or otherwise.

In step S20, the supply manager 22 may cause a pause or cessation of a print job such that the user may replace or fill an input media source with a medium or media. For example, the user interface 30 may display a message (e.g., “Paper tray 1 is empty.”) to the user that indicates that a desired medium or media should be placed into one or more input media sources (e.g., 210, 212, or 214).

The user interface 30 allows the establishment of associations between input media and media identifiers (e.g., receiver identifiers or paper tags). When the operator loads input media in a corresponding input media source (e.g., input paper tray), the user identifies the input media identifier associated with the respective input media source identifier. The supply manager 22 may use the associations to route input media through the document production system 10. The document production system 10 or the supply manager 22 then automatically chooses one or more media input sources whenever that input media is desired with no image from the marking engine 12. If a particular desired media type (e.g., secondary media) is not available in the inserter 14, but is available in the marking engine 12 or from another media source, the supply manager 22 chooses the available supply of the desired media (e.g., secondary media). Subsequently, the desired media may be processed through the marking engine 12 without imaging (e.g., marking or printing on) the desired media. The selection of available media from alternate input media sources increases the flexibility of the document production system 10 in terms of variety of media types available for processing and the available capacities the media types.

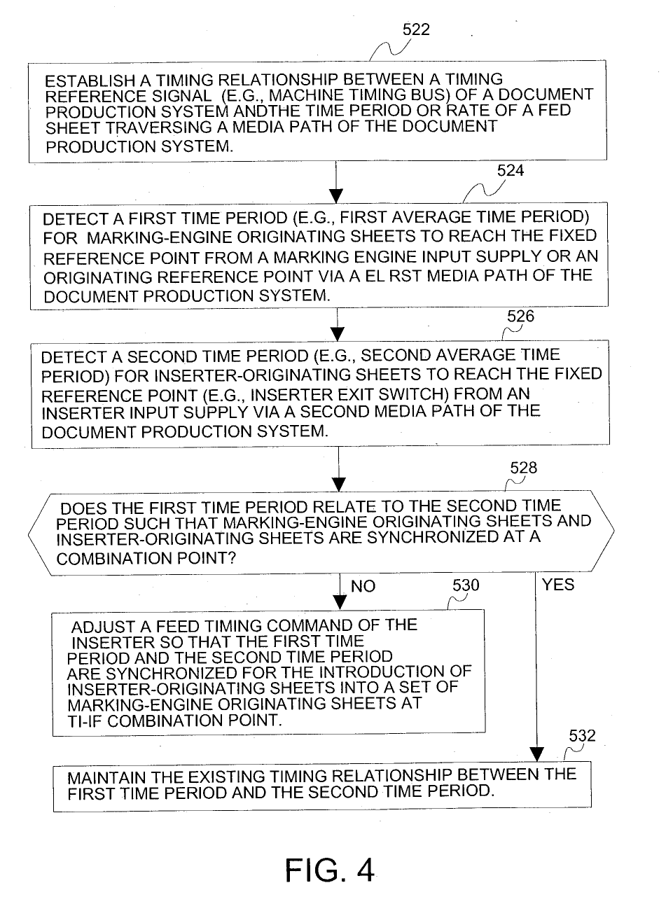

FIG. 4 is a flow chart of a method for managing a document production system 10. The method of FIG. 4 particularly addresses the management of timing constraints of a marking engine 12 with respect to an inserter 14 such that the assembly and formation of a print job is completed in a temporally coordinated manner.

The method of FIG. 4 may be invoked in accordance with several alternate techniques. Under a first technique, the method of FIG. 4 may be invoked automatically by a document production system (e.g., document production system 10) at a regular time interval or periodically. For example, a controller (e.g., controller 20) may contain a timer that expires upon the passage or lapse of the regular time interval. Under a second technique, the method of FIG. 4 may be invoked following a cycle of the reproduction of a certain volume of sheets. Under a third technique, the method of FIG. 4 may be invoked by a technician at any suitable time to recalibrate the document production system (e.g., document production system 10). The method of FIG. 4 begins in step S22.

In step S22, a user establishes a timing relationship between a timing reference signal (e.g., machine timing bus) of a document production system 10 and a time period or rate of a fed sheet traversing a media path (e.g., the first media path 202 or the second media path 204) of the document production system 10.

In step S24, a timing analyzer 24 or the controller 20 detects a first time period (e.g., a first average time period) for one or more marking-engine originating sheets to reach the fixed reference point from a marking engine 12 input supply or an originating reference point via the first media path 202 of the document production system 10. The first media path 202 may comprise the horizontal bypass path of the inserter 14.

In step S26, a timing analyzer 24 or the controller 20 detects a second time period (e.g., a second average time period) for at least one inserter-originating sheet to reach the fixed reference point from a media input source (e.g., 210, 212, or 214) of the inserter 14 via a first media path of the document production system 10. The first media path 202 may refer to a generally vertical media path 204 of the inserter 14. The fixed reference point may comprise the exit 208 or an exit switch associated with the exit 208. The first media path 202 and the second media path 204 may merge at a combination point 206. Although step S26 follows step S24 as illustrated in FIG. 4, steps S24 and S26 may be performed in any order or simultaneously, while falling within the scope of the invention.

In step S28, the data processor 26 or the controller 20 determines if the first time period (e.g., first average time period) relates to the second time period (e.g., second average time period) such that the marking-engine originating sheets and the inserter-originating sheets are synchronized at a combination point 206. The inserter-originating sheets and the marking-engine originating sheets are synchronized at a combination point 206 if the inserter 14 is able to insert desired sheets of media (e.g., secondary media) into the first media path 202 from the second media path 204 during uninterrupted or continuous operation of the inserter 14 so as to form a desired output of a document production system 10. The desired output of the document production system 10 may be consistent with a print job requirement entered from a user via the user interface 30, for example.

In one embodiment, the first time period (e.g., first average time period) is properly related to the second time period (e.g., second average time period) such that the marking engine 12 is synchronized with the inserter 14 if sheets of media (e.g., primary media) from the marking engine 12 may be interleaved with sheets of media (e.g., secondary media) from the inserter 14 in accordance with a plan, consistent with entries or selections of the user interface 30. If the first time period is related to the second time period, such that the marking engine 12 is synchronized with the inserter 14, the method continues with step S32. However, if the first time period is related to the second time period such that a marking-engine originating sheet and an inserter-originating sheet are not synchronized at a combination point 206, then the method continues with step S30.

In step S30, the timing adjuster 28 provides an adjustment signal to adjust feed timing command of the inserter 14 so that the first time period and the second time period are synchronized for the introduction of one or more inserter-originating sheets into a set of marking-engine-originating sheets at the combination point 206.

Step S30 may be accomplished in accordance with various techniques. In accordance with a first technique, primary sheets from the first media path 202 are merged with secondary sheets from the second media path 204 to provide an output of shingled sheets. In accordance with a second technique, primary sheets from the first media path 202 are merged with secondary sheets from the second media path 204 to provide an output of stacked sheets. The second technique represents an alternative to the first technique. In accordance with a third technique, secondary sheets from the second media path 204 are inserted into the first media path 202 when a skipping of printing of at least one sheet of primary media occurs. In accordance with a fourth technique, the controller adjusts a feed timing command of the inserter 14 to compensate for a change in a voltage level of an input energy source to the document production system. The feed timing command is adjusted to maintain coordinated feeding of sheets between the marking engine 12 and the inserter 14.

In step S32, the timing adjuster 28 or controller 20 maintains the existing timing relationship between the first time period and the second time period.

In order to maintain the precise timing synchronization over varying conditions and to compensate for machine-to-machine variability, the document production system 10 may invoke certain countermeasures. For example, when the inserter 14 is first mated with the marking engine 12 of the document production system 10, it is necessary to compensate for manufacturing variability that could effect timing of feeding media through the document production system 10.

The controller 20 first determines a first timing of sheets coming from the marking engine 12 as they arrive at the exit 208 (e.g., inserter exit switch) relative to the signals from the machine timing bus (MTB). Once the first timing is characterized, a second timing for the inserter sheets from at least one input media source (e.g., input media source 210) is determined. The first timing is compared to the second timing. The second timing of the feed command for the inserter sheets is then altered to compensate for discrepancies between the first timing and the second timing. The foregoing timing analysis and adjustment is then repeated for the remaining inserter media sources (e.g., 210, 212, or 214).

In an alternate embodiment, the controller 20 continuously updates the feed-timing adjustments of the inserter 14 by monitoring the relative sheet timing and adjusting the feed time for succeeding sheets accordingly.

If the input voltage to the marking engine 12 and the inserter 14 is varied, the speed of the media transport mechanisms within the inserter 14 and the marking engine 12 may differ such that the pages are not fed in a synchronized manner, unless the controller 20 provides compensation in accordance with the invention. In one embodiment, the marking engine 12 is driven by an asynchronous induction motor and the inserter 14 is driven by a synchronous motor 216. Consequently, as the input voltage to the marking engine 12 and the inserter 14 decreases, the marking-engine speed may decrease, but the inserter speed would remain constant without compensation of the controller 20. The controller 20 provides compensation in the relative timing between the inserter 14 and the marking engine 12 to assure coordinated feeding of media sheets and print job completion.

In one embodiment, the countermeasure or compensation for input voltage fluctuation of the controller 20 comprises adjusting the inserter-feed-timing of the inserter 14 with respect to the marking engine feed timing as the marking engine 12 speed changes. By monitoring the marking engine speed rather than input voltage to the document production system 10 or the marking engine 12, the document production system 10 may compensate for input voltage variations and torque variations in the transport mechanisms of the inserter 14 and the marking engine 12, simultaneously. Because the machine timing bus (MTB) includes the start of frame and image encoder signals, the marking-engine speed of the marking engine 12 is known.

In general, the controller changes the sheet timing or speed of the inserter 14 relative to the sheet timing or speed of the marking engine 12. In an alternate embodiment, the controller 20 may adjust independently the feed speed of associated with each input media source of the inserter 14. Further, the feed timing or speed for each input media source or its associated transport mechanism is adjusted to compensate for the change in the marking-engine sheet timing. The adjustment for each input media source may be different for each input media source (e.g., 210, 212 or 214). The controller 20 may determine or approximate the desired compensation by evaluating a linear relationship between the marking engine speed and the feed timing adjustment for each input media source (e.g., 210, 212 or 214) of the inserter 14. The machine speed may be calculated from the MTB signal at the start of each run.

In another alternate embodiment, if more precise sheet timing is warranted, including reducing sheet to sheet variability, an additional countermeasure can be utilized. Fine adjustments to individual sheet timing can be performed by altering the speed of one or more sets of nip rollers based on the arrival time of a particular sheet. For instance, the last set 209 of nip rollers in the inserter 14 could have an independent variable speed drive and could adjust its speed for some period of time based on the sheet arrived time at the exit 208 or an exit switch associated with exit 208. The upstream nip rollers would either need to change speed accordingly or be disengaged to allow nip rollers 209 to control the sheet.

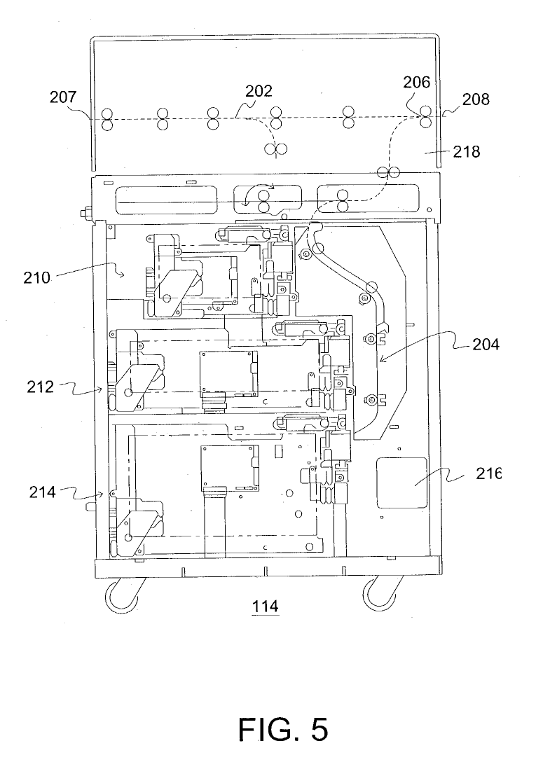

FIG. 5 shows an alternate embodiment of an inserter 114. The inserter 114 of FIG. 5 is similar to the inserter 14 of FIG. 2, except that the inserter 114 of FIG. 5 further comprises a sheet inverter 218 that is capable of flipping over sheets coming from the marking engine 12 prior to transporting them to the finishing device (e.g., a stapler) or another marking engine. A diverter supports the inverter 218 by allowing the option of flipping over of the inputted sheets or maintaining the incoming orientation of the sheets. The incoming orientation of the sheets refers to the orientation of the sheets at the entrance 207 of the inserter.

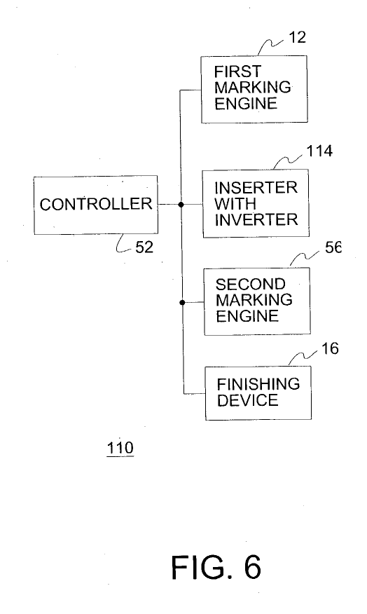

The inverter 218 of FIG. 5 may be located between the first media path 202 and an input media source (e.g., input media source 210). The inverter 218 may be used to flip over a sheet or medium that originates from the marking engine 12. Accordingly, the configuration of the document production system may conform to that of FIG. 6 to take advantage of the processing capabilities of the inverter 218.

In FIG. 6, a document production system 110 includes a first marking engine 12 coupled to an inserter 114 with an inverter. In turn, the inserter 114 is coupled to a second marking engine 56. The second marking engine 56 may be associated with the finishing device 16. The controller 52 is associated with a first marking engine 12, the inserter 14, the second marking engine 56 and the finishing device 16. Advantageously, the first marking engine 12 may be used to print on one side of a medium or media, whereas the second marking engine 56 may be used to print on an opposite side of the medium or media. The inserter 114 with the inverter may invert the sheet or medium outputted by the first marking engine 12 in preparation for marking or printing by the second marking engine 56. From the second marking engine 56, the printed or non-printed media may be fed to a finishing device 16 for further processing.

The inserter 114 of FIG. 5 may feature a secondary exit that is at a different level than the exit 208 of the first media path 202. For example, the secondary exit may be substantially lower than the exit 208 of the first media path 202 to be compatible with a media entrance of a second marking engine 56 coupled to an output of the inserter 114, as illustrated in FIG. 6. The foregoing alignment of the inserter entrance 207, media path, and exit would allow sheets to be directed into a second marking engine 56. If the sheets are flipped by the inverter 218, the sheets would be imaged on both sides at a rate twice that of the first marking engine 12, without the need of increasing the feed rate, imaging speed, sheet combining speed, or finishing speed.

The foregoing detailed description is merely illustrative of several physical embodiments of the invention. Physical variations of the invention, not fully described in the specification, may be encompassed within the purview of the claims. Accordingly, any narrower description of the elements in the specification should be used for general guidance, rather than to unduly restrict any broader descriptions of the elements in the following claims.

The following is claimed:

1. A method for managing a document production system, the method comprising:
detecting a first time period for at least one marking-engine originating sheet to reach a fixed reference point via a first media path of the document production system;
detecting a second time period for at least one inserter-originating sheet to reach the fixed reference point via a second media path of the document production system; and
adjusting a feed timing command of an inserter so the first time period and the second time period are synchronized for the coordinated introduction of at least one inserter-originating sheet into a set of marking-engine originating sheets at a combination point.

2. The method according to claim 1 further comprising:
establishing a timing relationship between a timing reference signal of the document production system and a time measurement of a fed sheet traversing the first media path of the document production system to support the detecting of the first time period.

3. The method according to claim 1 further comprising:
establishing a timing relationship between a timing reference signal of the document production system and a time measurement of a fed sheet traversing the second media path of the document production system to support the detecting of the second time period.

4. The method according to claim 1 wherein the detecting of the second time period is based on detection of an interval for at least one inserter-originating sheet to reach the fixed reference point from an input media source of the inserter via the fist media path.

5. The method according to claim 1 wherein the detecting of the first time period is based on detection of an interval for at least one marking-engine originating sheet to reach the fixed reference point from an input media source of the inserter via the second media path.

6. The method according to claim 1 further comprising:
merging sheets from the first media path and the second media path to provide an output of shingled sheets.

7. The method according to claim 1 further comprising:
merging sheets from the first media path and the second media path to provide an output of stacked sheets.

8. The method according to claim 1 further comprising:
inserting sheets from the second media path into the first media path when a skipping of printing of at least one sheet occurs.

9. The method according to claim 1 wherein the adjusting comprises adjusting the feed timing command of the inserter to compensate for a change in a voltage level of an input energy source to the document production system.

10. A document production system comprising:
a timing analyzer for detecting a first time period for at least one marking-engine originating sheet to reach a fixed reference point via a first media path of the document production system, the timing analyzer arranged to detect a second time period for at least one inserter-originating sheet to reach a fixed reference point via a second media path of the document production system;
a data processor for determining if the first time period relates to the second time period such that the at least one marking-engine originating sheet and the at least one inserter-originating sheet are synchronized for interleaving into an output set at a combination point;
an inserter for introducing at least one inserter-originating sheet into a set of marking engine originating sheets; and
a timing adjuster for adjusting a feed timing command of the inserter so the first time period and the second time period are synchronized for the coordinated introduction of inserter-originating sheets into a set of marking-engine originating sheets at the combination point.

11. The system according to claim 10 wherein the timing analyzer establishes a timing relationship between a timing reference signal of the document production system and a time measurement of a fed sheet traversing the first media path of the document production system to support the detecting of the first time period.

12. The system according to claim 11 wherein the timing reference signal comprises a machine timing bus.

13. The system according to claim 10 wherein the timing analyzer establishes a timing relationship between a timing reference signal of the document production system and a time measurement of a fed sheet traversing the second media path of the document production system to support the detecting of the second time period.

14. The system according to claim 13 wherein the timing reference signal comprises a machine timing bus.

15. The system according to claim 10 wherein the timing analyzer detects the first time period based on detection of an interval for at least one marking-engine-originating sheet to reach the fixed reference point from an input media source via the fist media path.

16. The system according to claim 10 wherein the fixed reference point comprises an inserter exit.

17. The system according to claim 10 wherein the timing analyzer detects the second time period based on detection of an interval for at least one inserter-engine originating sheet to reach the fixed reference point from an input media source via the second media path.

18. The system according to claim 17 wherein the fixed reference point comprises an inserter exit.

19. The system according to claim 10 further comprising a supply manager for allocating a least one sheet of a desired media from a corresponding input media source.

20. The system according to claim 10 further comprising:
an inverter for flipping over at least one sheet that traverses the first media path.

21. The system according to claim 10 further comprising:
a first marking engine for marking one side of at least one sheet in the first media path;
an inverter for flipping over at least one sheet in the first media path from the first marking engine; and
a second marking engine for marking an opposite side of the flipped sheet previously marked by the first marking engine.

22. A method for managing a document production system, the method comprising:
identifying media associated with corresponding input media sources;
determining if a desired medium is available from the input media sources of an inserter;
inserting the desired medium into the printed media outputted by a marking engine if the desired medium is available.

23. The method according to claim 22 comprising:
determining if the desired medium is available from a media input source of the marking engine;
inserting the desired medium into the printed media printed by the marking engine.

24. The method according to claim 22 further comprising:
stopping a print job and displaying a message to a user that indicates that the desired medium should be placed in one of the input media sources.

25. The method according to claim 22 comprising:
detecting a first time period for at least one marking-engine originating sheet to reach a fixed reference point via a second media path of the document production system;
detecting a second time period for at least one inserter-originating sheet to reach a fixed reference point via a first media path of the document production system; and
adjusting a feed timing command of an inserter so the first time period and the second time period are synchronized for the coordinated introduction of inserter-originating sheets into a set of marking-engine originating sheets at a combination point.
